(19) United States
(12) Patent Application Publication
(10) Pub. No.: US 2025/0375632 A1
(43) Pub. Date: Dec. 11, 2025

(54) Fire Fighting Technique

(71) Applicants: Peter Aung Hla, WASHINGTON, DC (US); Myint Myint San, WASHINGTON, DC (US)

(72) Inventors: Peter Aung Hla, WASHINGTON, DC (US); Myint Myint San, WASHINGTON, DC (US)

(21) Appl. No.: 18/914,521

(22) Filed: Oct. 14, 2024

(51) Int. Cl. A62C 3/02; A62C 99/00

(52) U.S. Cl. CPC A62C 3/0235; A62C 3/0242; A62C 99/0045

(57) ABSTRACT

This patent is about fighting Wildfires and Large fires. Wildfires start from small fires. By the time people know a wildfire is burning in a remote area, it has grown so big that it is difficult to control or to extinguish. There are two steps to fight wildfires: to know it faster or earlier while the wildfire is small and to fight the fire efficiently. Large fires are explosions causing a factory or a train to burn. They are difficult to control by ordinary fire fighting techniques. An entity will have to monitor an area in real time using information from satellites and strategically placed monitoring thermal imaging devices and cameras near or in forests. Once a wildfire is confirmed, helicopters, airplanes and/or drones will be used to spread pellets or powder of dry ice on the fires. If necessary, water will be sprayed or spread after that.

### TECHNICAL FIELD

The present disclosure relates to extinguishing wildfires and large fires.

### BACKGROUND OF THE INVENTION

Wildfires are a big problem not only for the United States but also for most countries of the world. They destroy forests, plants, houses, people, livestock and more. They produce Carbon Dioxide, toxic fumes, soot and ashes and release them into the atmosphere. The soot and small particles that come out of the wildfires get blown off and when they drop on the snow in Arctic and Antarctica, the particles in the snow absorb more heat from the sun and snow melts faster, which leads to the rise of sea level. Carbon Dioxide produced by the wildfires leads to greenhouse effect which absorbs and radiates heat towards the Earth and it contributes to climate change.

According to CBS News, there were 60 wildfires of more than 100 acres in the U.S. on Sep. 1, 2024. Canada Government website stated that Canada was experiencing an unprecedented wildfire season. “As of Jun. 19, 2023, there have been 2,619 fires reported nationally in 2023, and an estimated 5.3 million hectares burned. The area burned to date is over 15 times larger than the 10-year average for this time of year.” “Current fire activity in Canada remains high and widespread: as of June 19 [2023], there are 415 active wildfires, with 203 out of control. As of June 13, affected provinces include British Columbia, Alberta, Ontario, Quebec, and Nova Scotia. An estimated 20,994 people remain evacuated across the country.” CNN reported on Sep. 20, 2023, “As of Wednesday afternoon, 65 fires were burning across NSW (New South Wales, Australia), nearly a third of which were uncontained”, the state's Rural Fire Service (NSWRFS) said in a statement on Facebook. “It's the worst risk we've faced since the Black Summer fires of 2019,” NSWRFS commissioner Rob Rogers said Tuesday, according to public broadcaster ABC, referring to the 2019-2020 bushfire season that killed dozens of people and a billion animals as it burned through more than 10 million hectares.

The situation in just these three countries shows how bad wildfires are and will be.

Currently, dumping water and fire retardants on the wildfires and building fire control lines or traditional water spraying by firefighters are the normal ways of fighting wildfires. By looking at the wildfires in the three countries, these firefighting techniques are not very effective. Thus, it is apparent that we need a new and effective wildfire firefighting technique.

### BRIEF DESCRIPTION OF THE INVENTION

In an aspect of the present disclosure, the system or process of confirming the wildfire: as soon as the main office to fight wildfires within an area (forests or county or district) receives the alerts given by satellites and/or thermal imaging camera monitors, the office—with the help of the information (obtained commercially from satellites or for free or from satellites maintained by the U-S Government and/or monitoring devices using thermal imaging cameras placed in or around forests)—should send UAV/drones to check and confirm the fire and the extent of it.

In an embodiment of the present disclosure, once the fire is confirmed, the process and preparation of spreading Dry Ice (including the decision of the amount of Dry Ice) on or around the fire should be started.

In another aspect of the present disclosure, the use of powder or pellets of Dry Ice to spread or dump or spray over, near, or around the fires.

In another aspect of the present disclosure, the use, constructing, and manufacturing of containers (similar to the tanks in FIGS. 1, and 2) with gas escape holes and a long narrow hole underneath to spread dry ice with a shut off cover (FIG. 3) to close off and open the hole under the Dry Ice tanks.

In another embodiment of the present disclosure, the containers for Dry Ice are to be carried by helicopters or airplanes or drones.

In yet another aspect of the present disclosure, the use, constructing, and manufacturing of water tank and pipes (FIG. 4) to spray water with a shut off valve to close off the pipes which is controlled mechanically or electronically or hydraulically.

In another embodiment of the present disclosure, the containers for water in are to be carried by helicopters or airplanes or drones.

### BRIEF DESCRIPTION OF DRAWINGS

FIG. 1 is a perspective view of an example metal tank for carrying dry ice to be transported by helicopters or UAV drones;

FIG. 2 is another perspective view of the example metal tank as shown in FIG. 1;

FIG. 3 is a bottom view of the example metal tank as shown in FIG. 1; and

FIG. 4 is a perspective view of an example water tank for spreading water after spreading dry ice.

### DETAILED DESCRIPTION OF THE INVENTION

There are two steps in fighting wildfires: early detection and extinguishing the fire.

Early Detection: A Wildfire starts with a single flame caused by lightning or a careless human. It then starts to grow. If there are no cloud covers, it could be seen from a satellite or a UAV or a drone or monitoring posts. That's why an area or forests should be monitored in real time for burning fire. Satellites from Google, the U-S Government and others are doing that. Then before the fire grows too big, it should be checked and confirmed that indeed it is a wildfire.

National Oceanic and Atmospheric Administration (NOAA) says, “NOAA uses two main types of satellites: Geostationary Operational Environmental Satellites (GOES) and polar-orbiting (Low Earth Orbiting) satellites. The GOES-R series, featuring the Advanced Baseline Imager (ABI), captures high-resolution images of Earth, detecting smoke plumes and heat from fires.

Polar-orbiting satellites, such as those in the Joint Polar Satellite System, are equipped with the Visible Infrared Imaging Radiometer Suite (VIIRS). VIIRS excels in capturing detailed imagery of fires both day and night, providing continuous global monitoring. With a spatial resolution of 375 meters per pixel, VIIRS can detect smaller, lower-temperature fires. Its Day-Night Band measures low-intensity visible light emitted by small and developing fires, enhancing nighttime fire detection. VIIRS also supports the HRRR-smoke model, which tracks wildfire smoke and provides forecasts up to 24 hours in advance.”

National Aeronautics and Space Administration (NASA) says, “The Fire Information for Resource Management System (FIRMS) provides access, with minimal delay, to satellite imagery, active fire/hotspots, and related products to identify the location, extent, and intensity of wildfire activity. FIRMS tools and applications provide geospatial data, products, and services to support the broader fire management community and to inform the general public. Global data are available within 3 hours of satellite observation: U.S. and Canada active fire detections are available in real-time.

Earth Fire Alliance, a global nonprofit coalition, will have more than 50 satellites that scan the globe every 20 minutes in search of wildfire activity.

Google Research says, “As part of Google's mission to help people access trusted information in critical moments, we use satellite imagery and machine learning (ML) to track wildfires and inform affected communities. Our wildfire tracker was recently expanded. It provides updated fire boundary information every 10-15 minutes, is more accurate than similar satellite products, and improves on our previous work. These boundaries are shown for large fires in the continental US, Mexico, and most of Canada and Australia. They are displayed, with additional information from local authorities, on Google Search and Google Maps, allowing people to keep safe and stay informed about potential dangers near them, their homes or loved ones.”

In addition to monitoring information from satellites, monitoring equipment including thermal imaging cameras strategically placed on buildings or poles or elevated places have to be used by the entity to fight wildfires. There are thermal imaging cameras that can alert fires. For example, FLIR A700 can be configured for early fire detection and can alert users about potential fire hazards. This camera is equipped with advanced video analytics capabilities, which include features like motion detection and intrusion detection. These analytics can be set up to detect unusual heat patterns that might indicate a fire, and then send alerts to users.

When a fire is detected by an image from satellites or monitoring equipment, drones with thermal imaging cameras or regular drones have to be sent out to confirm the fire.

Extinguishing the Fire: Whether it is a small or large wildfire or other large fires, depending on how big the fire is, each load of up to 440 lbs of dry ice have to be spread over the wildfire or over the area already burned or over the windward side of the fire. With other large fires, dry ice has to be spread on all sides of the fire to cut off the Oxygen from the surrounding area.

Traditional Fire fighting is to spray or dump water and chemicals onto the fire to extinguish it or to build firebreak to stop the fire from spreading.

However, this new method is to reduce the Oxygen content of the air surrounding the fire to under 15% to extinguish the fire by spreading Dry Ice onto the fire scene. The air around the fire is 78% Nitrogen, 21% Oxygen, 0.9% Argon and 0.04% Carbon Dioxide. With plenty of Oxygen, the fire will burn brighter and as the Carbon Dioxide produced by the burning is hot, it rises and creates low pressure at the base of the fire which sucks in more Oxygen to burn. Kate S. Zalzal wrote for the Earth Magazine saying, “They have found that fires, even if ignited, will not propagate if the atmospheric oxygen concentration is below 16 percent. At our modern oxygen level of 20.9 percent, fires ignite and propagate readily.”

A Wildfire that is burning has only three elements: Flames, Fuel (wood or dry leaves) and Oxygen from the air. Fuel and Oxygen combine with the help of the heat from the flames and produce more heat along with hot Carbon Dioxide and other toxic fumes which rise up into the sky because hot air is lighter. Oxygen from the cold surrounding air rushes in towards the flames because the pressure at the base of the fire is low and the burning goes on. When the Carbon Dioxide from the dry ice comes into the scene, it pushes out the Oxygen from the surrounding air that is rushing in to the flames. The flames cannot get Oxygen to continue burning and the flames of the fire are snuffed out. This Carbon Dioxide, unlike the hot Carbon Dioxide that comes out of the burning flames, is quite cold and so it does not rise up but rushes in to adjacent fires because the low pressure surrounding the burning flames suck in the cold Carbon Dioxide. In turn, the adjacent fire stops burning because it cannot get enough of the Oxygen it needs. Oxygen content needs to be more than 15% in the air for diffusion flame production and when the Carbon Dioxide from the dry ice expands and rushes into the fire, it stops burning as there is more Carbon Dioxide around the fire. When cold Carbon Dioxide from dry ice overwhelms the surrounding area, Oxygen cannot get near the fire and the fire will die down.

Pellets of Dry Ice will be sprayed or spread out over the fire or close to the fire. The pellets of Dry Ice should be big enough to survive the fall to the ground and small enough to sublimate quickly after hitting the ground.

Dry Ice is frozen Carbon Dioxide. It sublimates (evaporates directly into gas) at-78.5 degrees Celsius or-109.2 degrees Fahrenheit. Before the carbon dioxide gas gets to the Standard Temperature (0 degree Celsius), it absorbs the heat from the scene of the fire and as the Carbon Dioxide gets hotter, it expands. This cools the temperature of the scene of the fire.

Carbon Dioxide molecule has one Carbon atom (atomic weight 12) and two Oxygen atoms (each has atomic weight 16). As Carbon Dioxide has an atomic weight of 44 (12+16+16), there is 44 gm in one mole. One mole of gas at Standard Temperature and Pressure (0 degree Celcius and 1 ATM) is 22.4 Liters. So one pound (454 gm) of dry ice will have about 231 liters (61 gallons) of Carbon Dioxide gas at STP. The temperature at the fire scene can be hundreds of degrees. Let's assume it is about 200 degrees Celsius (It could be up to more than 1000 degrees Celsius). According to Boyle's and Charles' law P₁ V₁/T₁=P₂ V₂/T₂, The volume of Carbon Dioxide from the one pound of the dry ice without considering the air pressure would be more than 400 liters or 105 gallons. If 400 lbs of dry ice are dropped over the wildfire, the volume of Carbon Dioxide would be more than 42,000 gallons. When this Carbon Dioxide pushes into the wildfires, Oxygen does not have a chance to get in and combine with the fuel. Wildfire will be extinguished.

University of Massachusetts Amherst says in its Environmental Health & Safety page under the heading What are the hazards, “Cryogens and dry ice can expand 700 to 900 times their volume upon boiling/sublimation.” Department of Biology at the University of York says on its website that 10 kg of dry ice sublimes into about 5.4 cubic meters of carbon dioxide gas. And that the expansion ratio of dry ice is 845. That means 1 lb of dry ice would sublime into 6.5 gallons of carbon dioxide. So if this gas is heated from-78 degrees Celsius to 200 degrees, the volume would be about 158 gallons. 400 lbs of dry ice would produce more than 63,200 gallons of carbon dioxide gas.

Buckets used to carry water and dump on wildfires are 72 to 2,600 gallons. Wikipedia has a list of aircrafts that carry water or fire retardants and medium size is 10,000 gallons and heavy size is 20,000 gallons. Water or fire retardants that are dumped on fires do not expand like Dry Ice and extinguish fires only on contact.

The volume of Carbon Dioxide from the dry ice is several times greater than the water or fire retardants and also it can extinguish fires that the dry ice does not touch because the cold Carbon Dioxide can rush towards adjacent fires. So using dry ice to extinguish wildfires and large fires is much better.

Bill Gabbert wrote on Wildfire Today's article “The cost per gallon of dropping retardant” that according to the data from the US Forest Service, total cost estimate with fuel estimate ranged from about $9.8 million to $22.4 million in 2019. Approximate cost of retardant was from about $3.00 to $10.00 per gallon. The cost of dry ice is about $1.00 per lb.

CBS News said in Wildfire Watch, “However, starting in the early 2000s, [United States Federal wildfire fighting] spending began to rise, with several years exceeding $1 billion. The trend accelerated after 2010, with costs surpassing $2 billion in multiple years and peaking at nearly $4 billion in 2021.” California spent about $1.2 billion in the fiscal year ending Jun. 20, 2022.

Autumn Spanne wrote an article “We're dumping loads of retardant chemicals to fight wildfires. What does it mean for wildlife?” for the nonprofit organization Environmental Health Sciences. “Wildfire retardants are generally considered safe for humans, though some argue that the risks are insufficiently understood. In addition, scientists began raising concerns decades ago about the toxicity of retardants for wildlife. Sometimes pilots accidentally release retardant over restricted areas like endangered species habitat and waterways in highly concentrated doses. Once it enters streams, ponds, and rivers, retardant—particularly in concentrated quantities—can spur harmful algae blooms, and potentially kill fish, amphibians, and other aquatic organisms.” Carbon Dioxide released by dry ice is a gas and will not harm the environment or wildlife. It just moves to the fire and if it becomes hot enough, it rises like the smoke from the wildfire.

Using dry ice to fight wildfires and large fires is cheaper and more effective than other methods and will not harm the environment and wildlife. Carbon Dioxide to produce Dry Ice is reclaimed from industries and so it does not harm the environment. This method will protect and help forests, people, environment and the climate.

When fighting metal fires, one should be careful about the use of Dry Ice. “Note that certain metals react exothermically with nitrogen or carbon dioxide, so the only acceptable inert gases for these metals are helium and argon. Halons should not be used on metal fires.” (PDHonline Course M282: Fire Dynamics Series: Fire Protection Fundamentals. Instructor: Lawrence J. Marchetti. p-31).

According to Hazmat University, Dry Ice is regulated in transportation and shipping by aircraft is limited to 200 Kg (441 lbs).

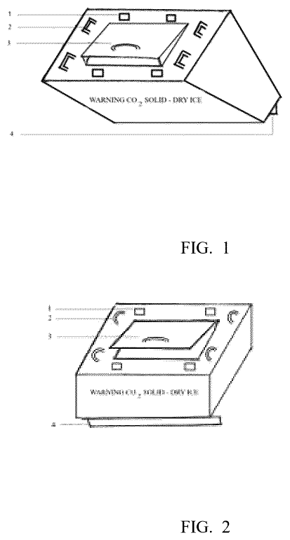

FIG. 1 is a perspective view of an example metal tank for carrying dry ice to be transported by helicopters or UAV drones according to an embodiment of the present disclosure. The metal tank includes escape holes 1 for Gaseous Carbon Dioxide, handles 2 to hook the tank to helicopters or drones (UAV), and a cover of the opening to fill up the tank.

FIG. 2 is another perspective view of the example metal tank as shown in FIG. 1, further including a long narrow opening 4 to drop Dry Ice and the cover of the opening.

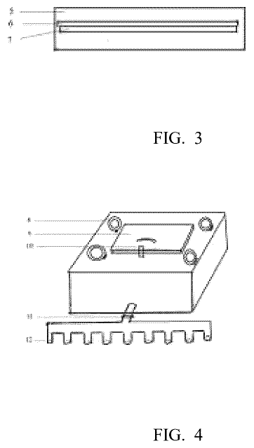

FIG. 3 is a bottom view of the example metal tank as shown in FIG. 1. The bottom of the metal tank includes a closing cover 6 of a long narrow opening 7 to drop Dry Ice. The cover 6 may be operated using, for example, Mechanical, Hydraulic or Electronic controls. The long narrow opening 7 is for spreading Dry Ice on to the scene of a fire.

FIG. 4 is a perspective view of an example water tank for spreading water after spreading dry ice. The metal tank includes handles 8 to hook the tank to helicopters or drones, a cover 9 of the opening to fill the water tank, a lock to lock the cover, and a water shut off valve 11. The water shut off valve 11 can be controlled, for example, mechanically, hydraulically or electronically from the planes or drones. The main pipe coming out of the tank can be on the side of the tank too. The water tank includes water pipes 12.

When the alerts from satellites or monitoring devices come in that there is a suspected fire, drones with thermal imaging cameras or regular drones should be sent out to confirm the fire. When the fire and the size of it are confirmed, the manager should decide how much Dry Ice would be needed and preparations should be made to spread small pellets of the Dry Ice on or around the fire by helicopters, planes or drones. If there is some fire remains, more Dry Ice or water can be spread over the fire scene.

After the Dry Ice is spread, water can be sprayed over the fire scene to cool down the burnt area or to extinguish embers and small fires.

The tanks to drop Dry Ice should be as wide as possible so that it will spread Dry Ice more and they are to be able to carry up to 440 lbs of Dry Ice unless special permits or allowance from the Federal Government or State Governments or Foreign Governments are obtained to carry more. Dry Ice tanks must have gas escape holes on top so that they will not explode.

After the fire is extinguished, drones with thermal imaging cameras should be sent to check whether there are any fires or hot spots remain.

1-7. (canceled)

8. A fire fighting technique for extinguishing wildfires comprising the steps of:
receiving an alert about a suspected wildfire;
deploying at least one drone to confirm the suspected wildfire exists;
in response to determining the fire exists, deciding how much Dry Ice is needed to extinguish the fire;
spreading, from above the fire, pellets of Dry Ice on or around the wildfire, wherein the pellets of Dry Ice is the amount needed to extinguish the fire; and
after spreading the pellets of Dry Ice, spraying water over the scene of the wildfire.

9. The fire fighting technique according to claim 8, wherein the at least one drone includes thermal imaging cameras.

10. The fire fighting technique according to claim 8, said pellet spreading step comprising spreading the pellets using helicopters, planes or drones.

11. The fire fighting technique according to claim 8, further comprising placing the pellets of Dry Ice in tanks, wherein the tanks include gas escape holes.

12. The fire fighting technique according to claim 8, further comprising deploying drones with thermal imaging cameras to check whether any fires or hot spots remain after the wildfire is extinguished.
